(19) United States
(12) Patent Application Publication
(10) Pub. No.: US 2016/0148411 A1
(43) Pub. Date: May 26, 2016

(54) METHOD OF MAKING A PERSONALIZED ANIMATABLE MESH

(71) Applicant: Right Foot LLC, Los Angeles, CA (US)

(72) Inventors: Steven Chen, Alameda, CA (US); Scott A. Harmon, Concord, MA (US)

(21) Appl. No.: 14/834,417

(22) Filed: Aug. 24, 2015

Related U.S. Application Data
(60) Provisional application No. 62/041,618, filed on Aug. 25, 2014.
(60) Provisional application No. 62/042,235, filed on Aug. 26, 2014.

(51) Int. Cl. G06T 13/40; G06T 15/20; G06T 17/10; G06K 9/62; G06T 17/20; G06T 5/00; G06K 9/46; G06K 9/00; G06T 7/40

(52) U.S. Cl. CPC G06T 13/40; G06K 9/00268; G06T 15/20; G06T 17/10; G06T 7/40; G06T 17/20; G06T 5/006; G06K 9/46; G06K 9/6215; G06T 2213/08; G06T 2200/04; G06K 2009/4666

(57) ABSTRACT

A method for automatically identifying the required inputs for software for generating a personalized animatable face mesh generally includes computer processing a two-dimensional image of the subject's face to automatically identify at least one facial landmark on the 2-D image. The at least one identified facial landmark is projected onto at least one feature point on a photogrammetric three-dimensional model of the face. The photogrammetric three-dimensional model of the face is processed by a computer to automatically identify frontal and profile feature points on the photogrammetric three-dimensional model so that all of the required inputs are identified automatically without operator intervention.

### CROSS-REFERENCED APPLICATION

This application claims priority to U.S. provisional application Ser. No. 62/041,618 filed on Aug. 25, 2014 and U.S. provisional application Ser. No. 62/042,235 filed on Aug. 26, 2014. The disclosures of the above-referenced applications are incorporated herein by reference in its entirety.

### FIELD

The present disclosure relates to image processing, and in particular to a method of making a personalized animatable mesh.

### BACKGROUND

This section provides background information related to the present disclosure which is not necessarily prior art.

The present disclosure relates to making personalized animatable face meshes, and in particular to an automated method of making personalized animatable face meshes.

Most conventional image processing software programs for generating animations from two dimensional images of subjects' faces typically require a user to identify a number of facial landmarks on the two dimensional images of the subjects' faces. While some of these facial landmarks can be automatically identified using facial recognition software, such as FaceSDK by Luxand Inc., many of these facial landmarks (e.g., features on the sides of the subjects' faces, features along the outer edge of the profile, e.g., the bridge and tip of the nose, the top and bottom lips, and the chin) previously could not be automatically identified and require users to manually identify these facial landmarks. Accordingly, the animation process could not be automated.

### SUMMARY

This section provides a general summary of the disclosure, and is not a comprehensive disclosure of its full scope or all of its features.

Embodiments of the present disclosure provide methods for automatically making a personalized animatable mesh of a face, including methods for automatically identifying the location of the frontal and profile facial landmarks that are necessary inputs for software to generate the personalized animatable mesh. Generally, the methods include computer processing a two-dimensional (2-D) image of the subject's face to automatically identify at least one of the facial landmarks on the 2-D image. The additional profile landmarks can be automatically identified based on at least one feature data in a statistical database.

In some embodiments, the at least one identified facial landmark can be projected onto a photogrammetric three-dimensional (3-D) model of the face, which is constructed from at least two 2-D images. The photogrammetric 3-D model of the face is processed by a computer to automatically identify the frontal and profile feature points on the photogrammetric 3-D model so that all of the required inputs of the software for generating an animatable facial mesh are identified automatically without operator intervention.

In some embodiments, the 2-D image can be a virtual 2-D image generated from at least two 2-D images of the face or acquired from a camera scanning the photogrammetric 3-D model. The virtual 2-D image can include a plurality of frontal view features of the face rendered from the at least two 2-D images or the photogrammetric 3-D model.

In some embodiments, the at least one facial landmark on the 2-D image can be automatically identified by facial feature recognition software.

In some embodiments, the photogrammetric 3-D model preferably includes a plurality of polygons with vertices. The step of projecting the at least one identified facial landmark onto the photogrammetric 3-D model of the face preferably includes texture mapping the at least one facial landmark onto at least one identified feature point on the photogrammetric 3-D model. Preferably, this step can be implemented by identifying at least one polygon on the photogrammetric 3-D model, where the at least one identified polygon contains a texture coordinate corresponding to the at least one facial landmark. Additionally or alternatively, a closest vertex on the photogrammetric 3-D model can be assigned to one of the at least one identified feature point on the photogrammetric 3-D model.

In some embodiments, the photogrammetric 3-D model preferably includes a plurality of triangles with vertices.

In some embodiments, the at least one identified feature point on the photogrammetric 3-D model can be used to fit the photogrammetric 3-D model with a generic 3-D mesh.

In some embodiments, the generic 3-D mesh is preferably a Candide mesh. The Candide mesh preferably includes a plurality of polygons with vertices. Additionally, the Candide mesh can be globally transformed to match up with the photogrammetric 3-D model in order to reduce the distance between corresponding points between the Candide mesh and the photogrammetric 3-D model. The Candide mesh may include at least one pre-defined feature point. The at least one pre-defined feature point location can be represented by a weighted sum of one or more vertices on the Candide mesh. The global transformation can be implemented by calculating at least one global correction parameter based on a relationship between the at least one projected feature point on the photogrammetric 3-D model and the at least one corresponding pre-defined feature point on the Candide mesh. The at least one global correction parameter preferably includes a scale, a rotation and a translation that minimize an error function representative of the distances of corresponding points between the Candide mesh and the photogrammetric 3-D model. Applying the at least one global correction parameter to the Candide mesh can move at least some vertices of the Candide mesh based on the at least one global correction parameter.

In some embodiments, at least one facial shape parameter is calculated for applying a particular deformation to at least one vertex on the Candide mesh so that the deformed Candide mesh is personalized.

In some embodiments, additional profile feature points on the transformed Candide mesh can be automatically identified/extrapolated based on the corrected at least one corresponding pre-defined feature point of the transformed Candide mesh.

In some embodiments, a personalized animatable mesh of the face can be created based on the at least one corrected corresponding pre-defined feature point and the virtual 2-D image.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a flow chart of a preferred embodiment of method of making a personalized animatable mesh;

FIG. 2 is a 2-D image of a face acquired by a camera from left bottom;

FIG. 3 is a 2-D image of the face acquired by a camera from left top;

FIG. 4 is a 2-D image of the face acquired by a camera from right bottom;

FIG. 5 is a 2-D image of the face acquired by a camera from right top;

FIG. 6 is a virtual 2-D image synthesized by the 2-D images of FIGS. 2-5;

FIG. 7 is the virtual 2-D image of FIG. 6 showing the automatic identification of frontal facial landmarks;

FIG. 8 is a frontal view of a photogrammetric 3-D model generated from the 2-D images of the face;

FIG. 9 is a perspective view of the photogrammetric 3-D model of FIG. 8;

FIG. 10 is a side view of the photogrammetric 3-D model of FIG. 8;

FIG. 11 is a perspective view of the photogrammetric 3-D model of FIG. 8 having texture features of the face;

FIG. 12 is a side view of the photogrammetric mesh of FIG. 8 with feature points projected from the identified frontal facial landmarks of the virtual 2-D image of FIG. 6;

FIG. 13 is a perspective view of the photogrammetric 3-D model of FIG. 8 with feature points projected;

FIG. 14 is a Candide mesh with its polygons colored;

FIG. 15 is a depiction of overlaying the Candide mesh of FIG. 14 on a face model without any correction;

FIG. 16 is a depiction of overlaying a corrected Candide mesh on the face model of FIG. 15;

FIG. 17 is a depiction of overlaying an uncorrected Candide mesh on the photogrammetric 3-D model of FIG. 8;

FIG. 18 is a depiction of overlaying a corrected Candide mesh with corrected corresponding pre-defined feature points on the photogrammetric mesh of FIG. 8;

FIG. 19 is an exemplary FaceGen mesh with uncorrected feature points projected from a 2-D image;

FIG. 20 is a depiction of the FaceGen mesh adjusted based on the corrected projected feature point locations;

FIG. 21 is a frontal view of a FaceGen mesh generated from the virtual 2-D image of FIG. 6;

FIG. 22 is a perspective view of the FaceGen mesh of FIG. 21;

FIG. 23 is the uncorrected FaceGen mesh showing the corrected corresponding pre-defined feature point locations on the corrected Candide mesh of FIG. 18;

FIG. 24 is a frontal view of a textured corrected FaceGen mesh of FIG. 23 with corrected location of the feature points; and

FIG. 25 is a personalized animatable mesh.

Corresponding reference numerals indicate corresponding parts throughout the several views of the drawings.

### DETAILED DESCRIPTION

Example embodiments will now be described more fully with reference to the accompanying drawings.

Embodiments of the present disclosure provide methods for making a personalized animatable mesh, which can automatically identify the location of necessary frontal and profile feature points for generating the personal animatable mesh. Thus embodiments of the present disclosure can be used to construct a digital avatar to be used in anything from animated movies to the latest videogame. Moreover, the core digital avatar can be customized in an unlimited number of ways. Hair color, eye color, makeup, skin color, even fantasy treatments and animation are possible.

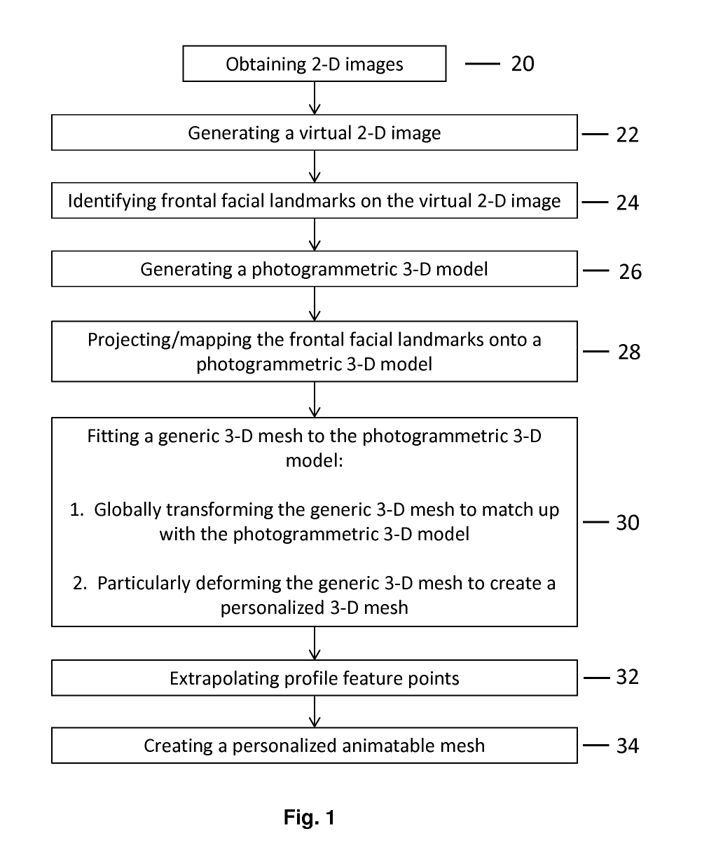

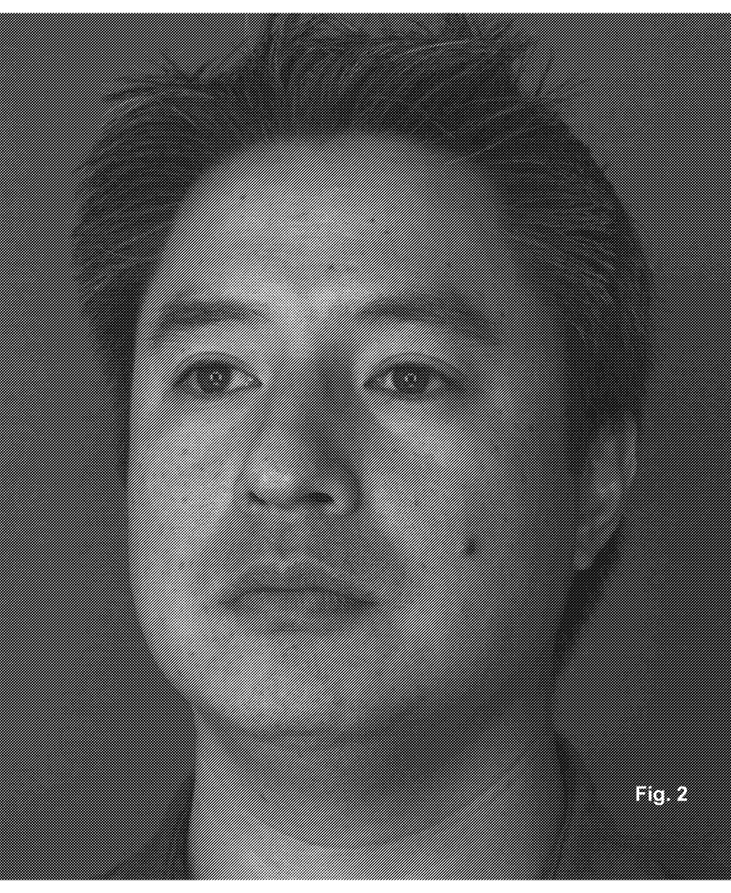

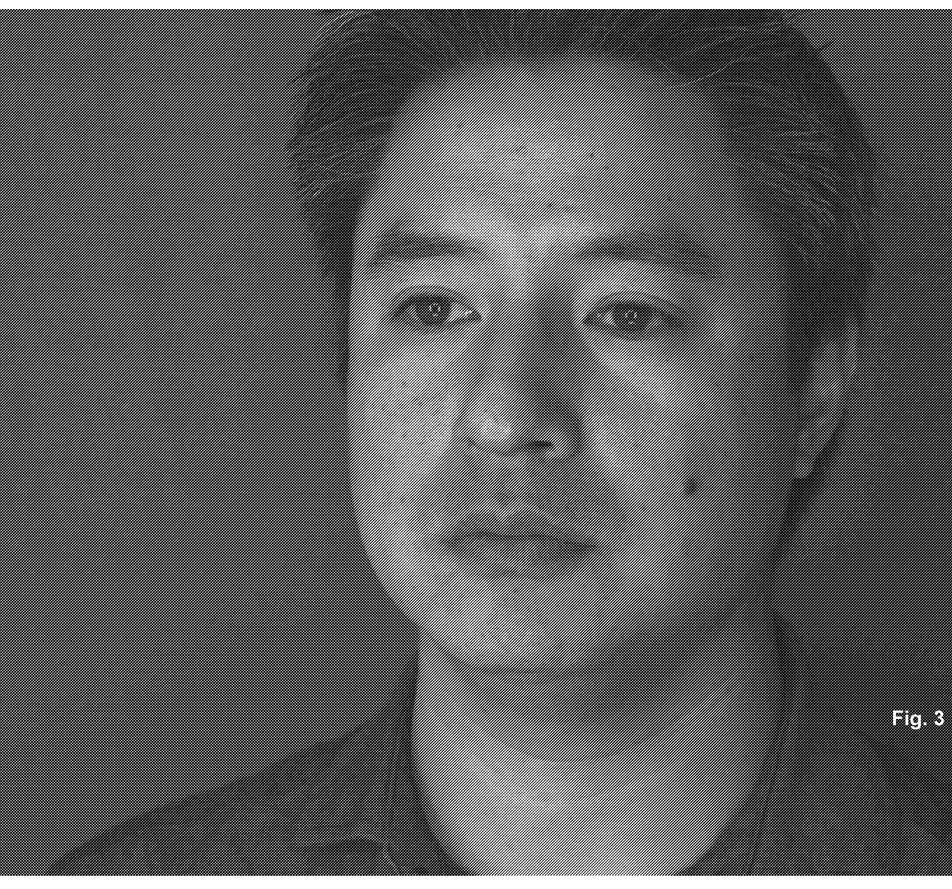

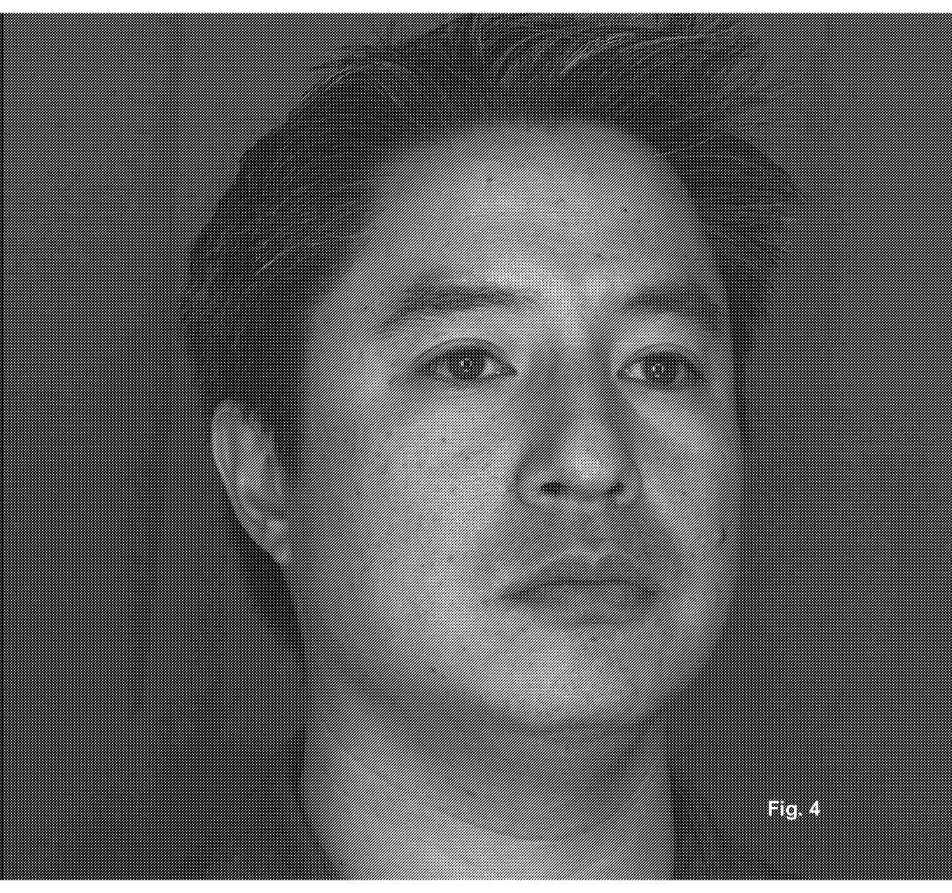

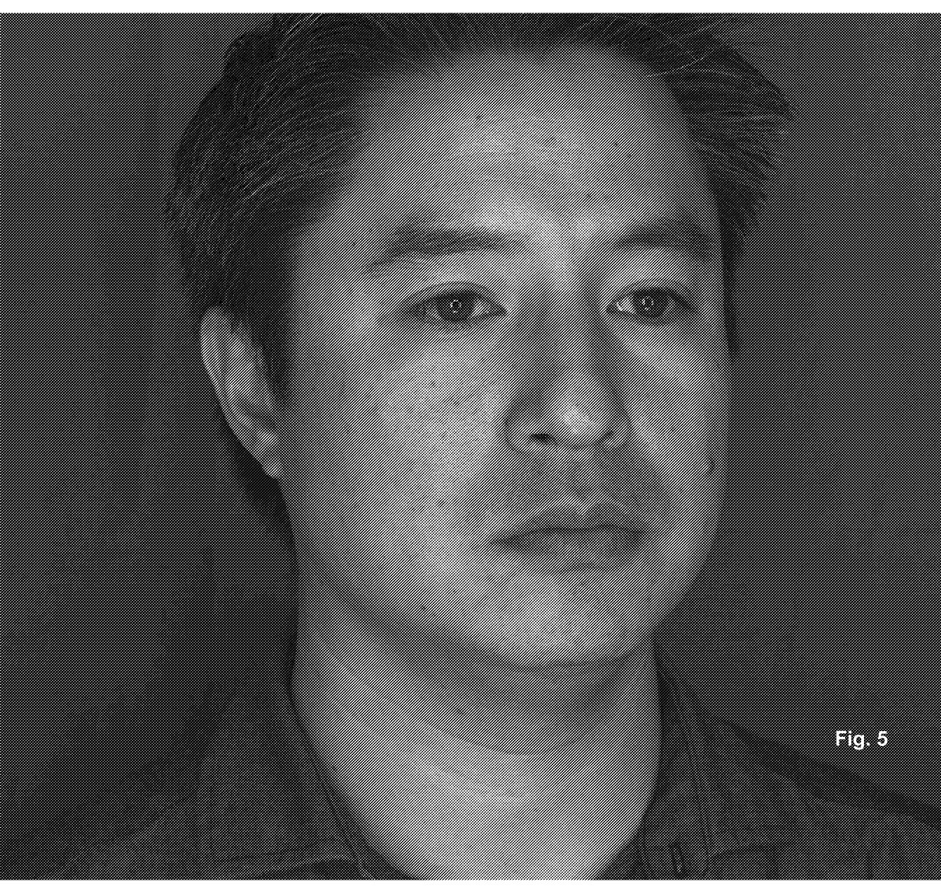

As shown in FIG. 1, the method includes at 20, obtaining at least two 2-D images of the subject's face. The at least two 2-D images can be acquired by at least two cameras from different points of view. For example, the at least two 2-D images can be a left view image and a right view image acquired by a left camera and a right camera respectively. In some exemplary embodiments, four 2-D images of the subject's face can be captured, a left top view image, a left bottom view image, a right top image and a right bottom image, as shown in FIGS. 2-5. In some other embodiments, the number of 2-D images can be any number greater than two.

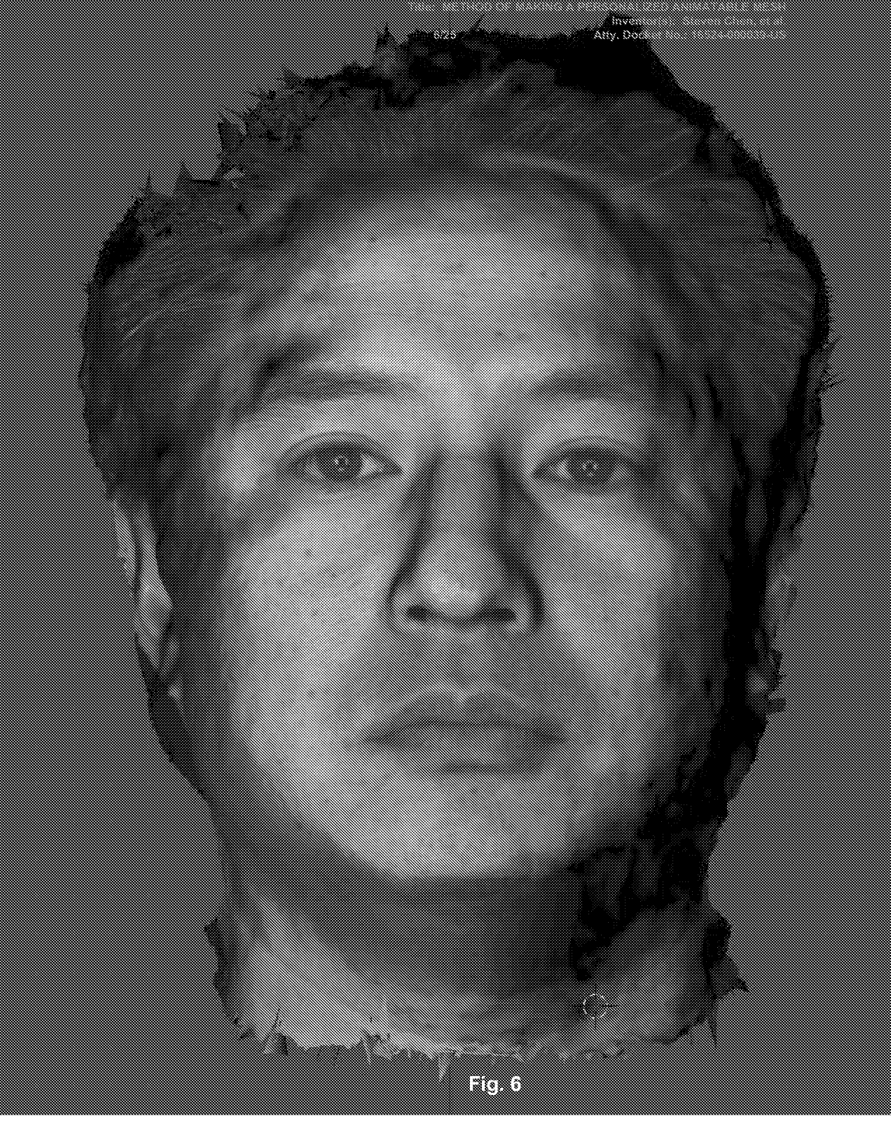

At 22 a virtual 2-D image of the subject's face as shown in FIG. 6 can be generated by synthesizing the at least two 2-D images of the subject's face from step 20. Alternatively, the virtual 2-D image can be acquired by a camera scanning a photogrammetric 3-D model generated by the 3-D photogrammetry software.

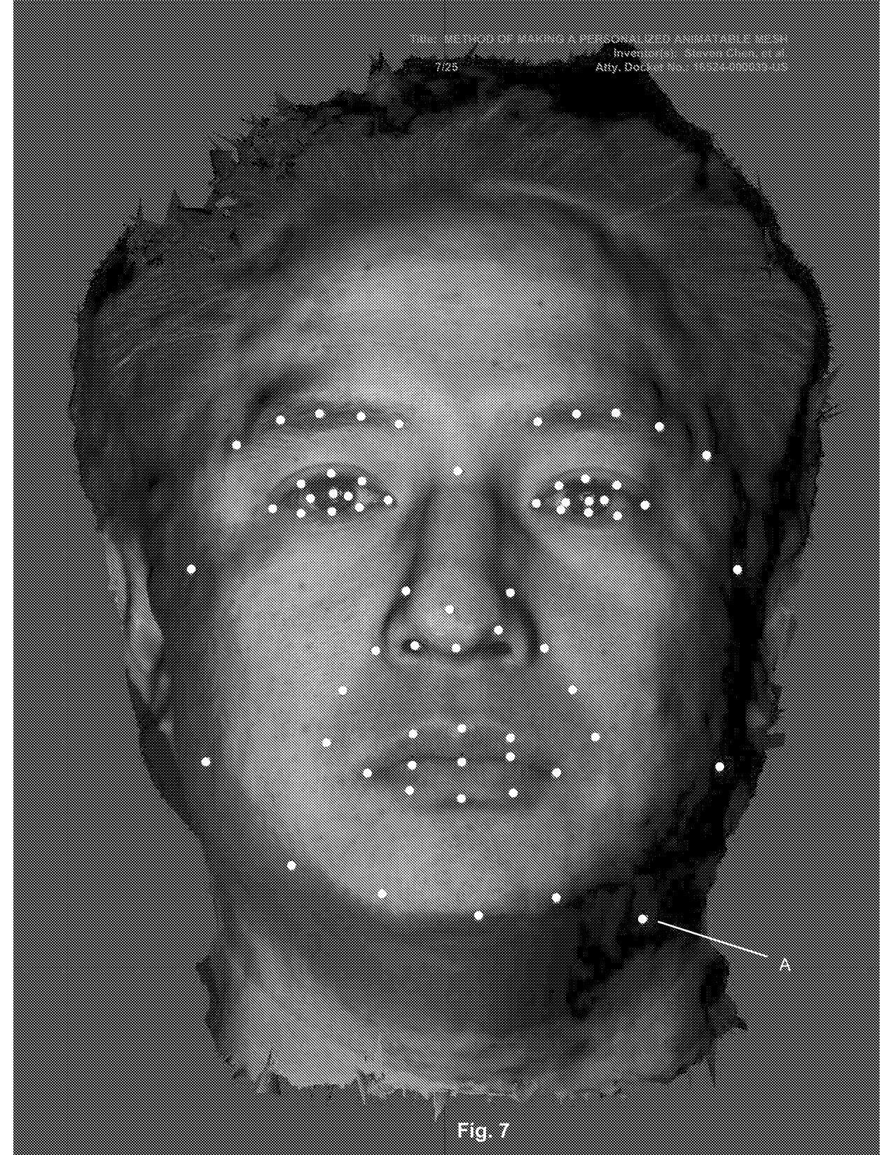

At 24 the virtual 2-D image is processed by a computer using facial feature recognition software to identify frontal facial landmarks on the virtual 2-D image. The 2-D facial landmarks recognition is performed on the textured virtual 2-D image. This can be done using standard software, such as FaceSDK, and can produce a list of (i,j) pixel coordinates in the virtual image space to indicate the location of facial landmarks, e.g., the centers of the eyes, the edges of the eyes, the tops of the eyes, the bottoms of the eyes, the edges of the mouth, the top of the mouth, the bottom of the mouth, the corners of the mouth, the tip of the nose, the edges of the nostrils, the edges of the cheeks, and the chin, etc., as shown in FIG. 7.

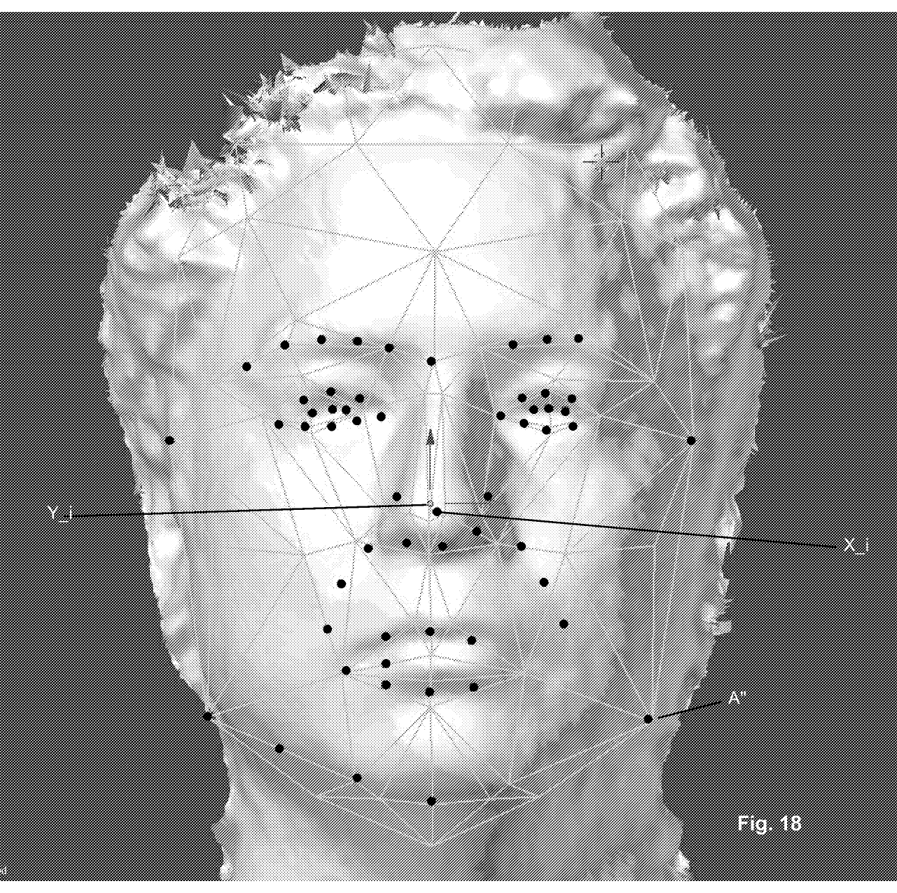

In some embodiments, the location of the facial landmarks can be automatically identified based on at least one feature data in a statistical database. Different software packages will produce different sets of landmarks, and it may be necessary to extrapolate the positions of features that are required if they are not provided by the software. For example, the location of the cheek bones can be extrapolated by fitting an ellipse through a set of landmarks along the lower jaw line. Depending on the quality of the image, these features are often not detected well, and therefore the cheek bone positions may not be consistent. For example, the detected point A on FIG. 7 is off the jaw line due to the image quality. Example of such inconsistencies can be corrected later after projecting the identified facial landmarks onto a photogrammetric 3-D model, as shown with point A″ in FIG. 18.

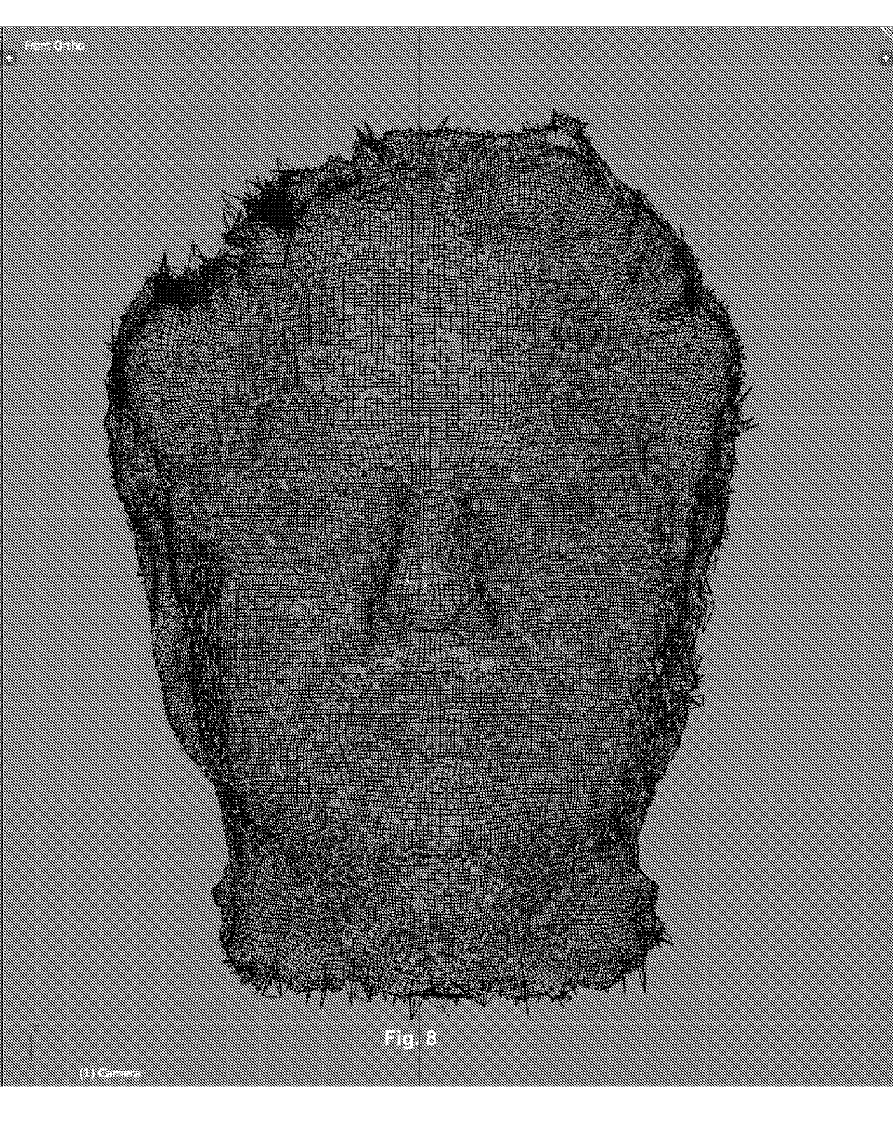

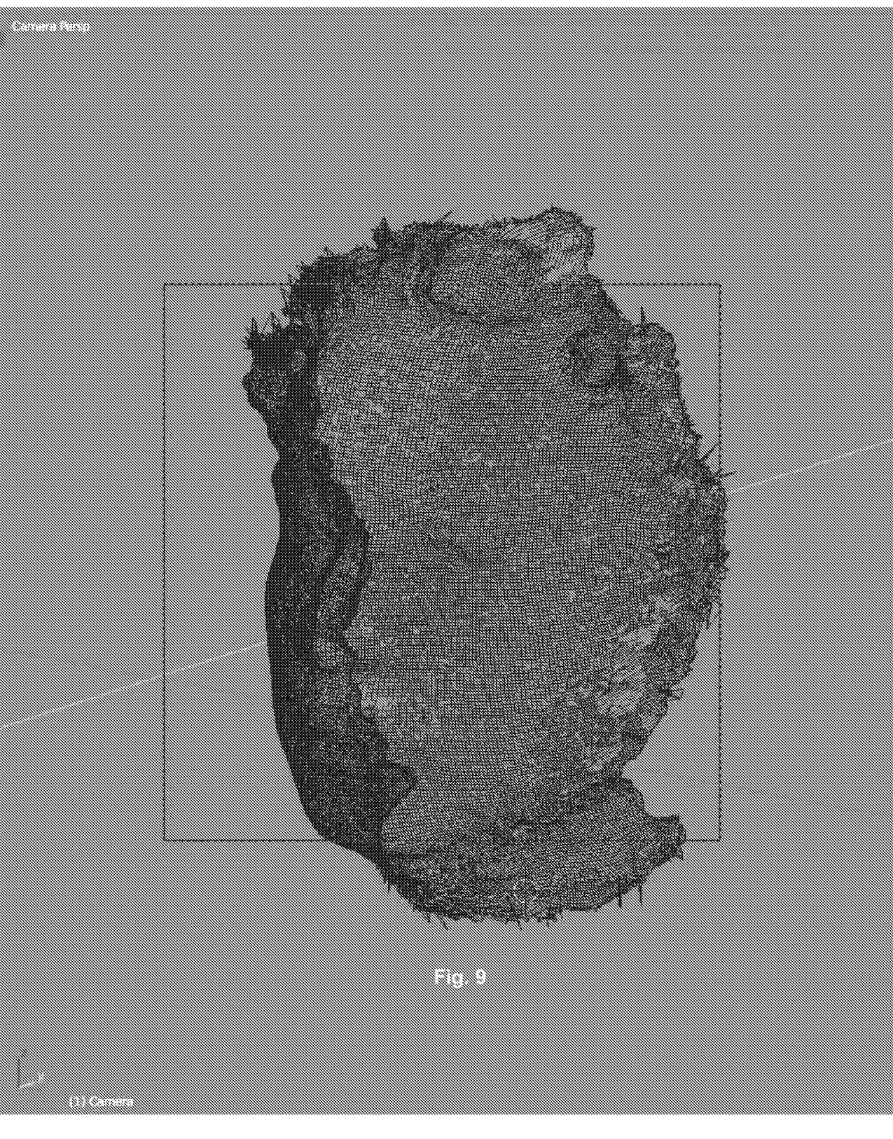

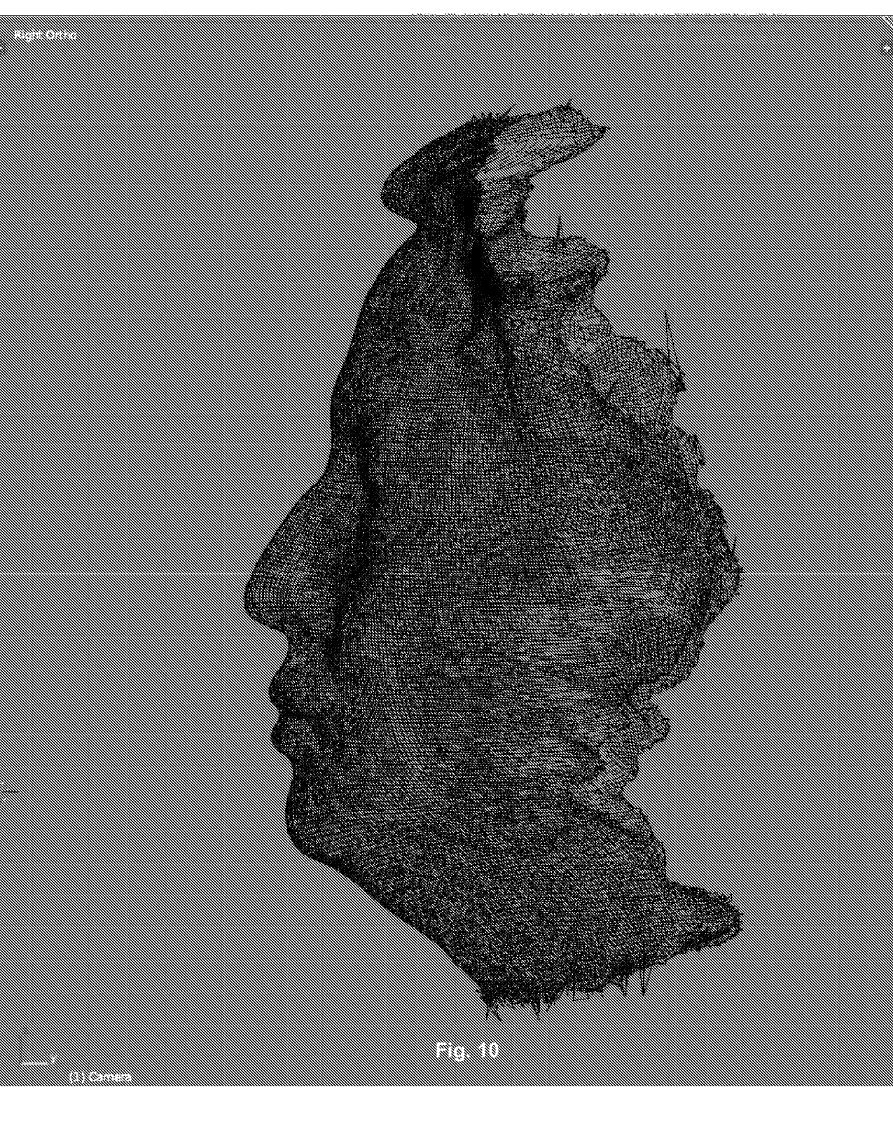

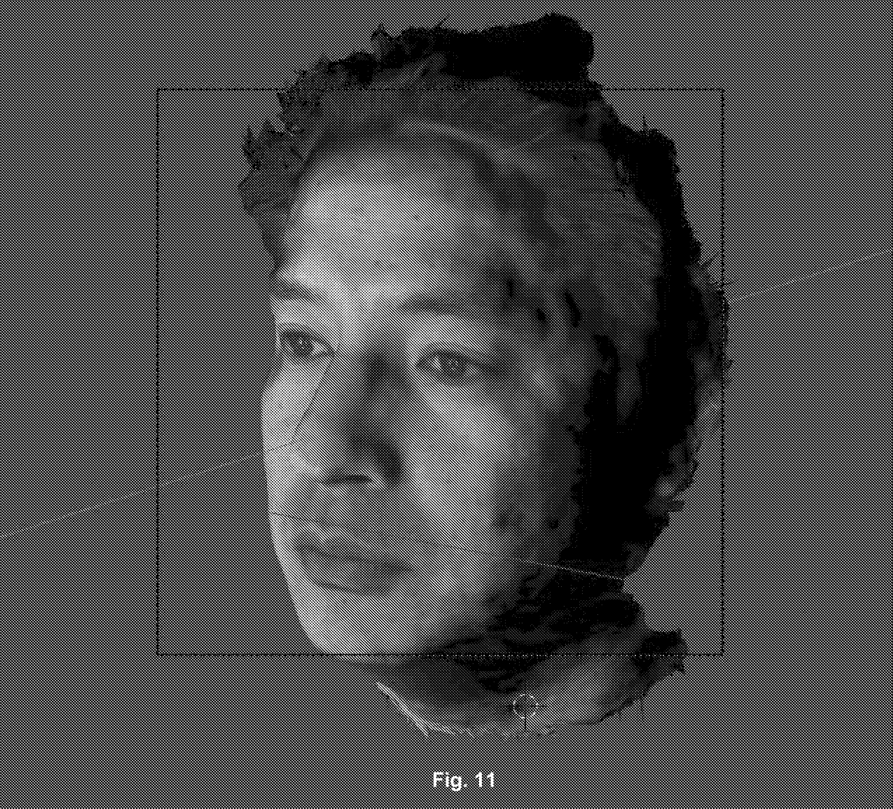

At 26 the photogrammetric 3-D model of the subject's face, as shown in FIGS. 8-10, can be generated using a photogrammetry software package by the at least two 2-D images of the subject's face from step 20. Dimensional Imaging Ltd. has developed software useful for this purpose. This software provides a photogrammetric 3-D model of the subject's face textured with an image that is suitable for feature detection. As shown in FIG. 11, the texture image is a frontal view image of the subject's face, which can be acquired from one of the cameras used in the scanning process, or a blending/synthesizing of the images from multiple cameras, so that the image is a head-on image of the subject.

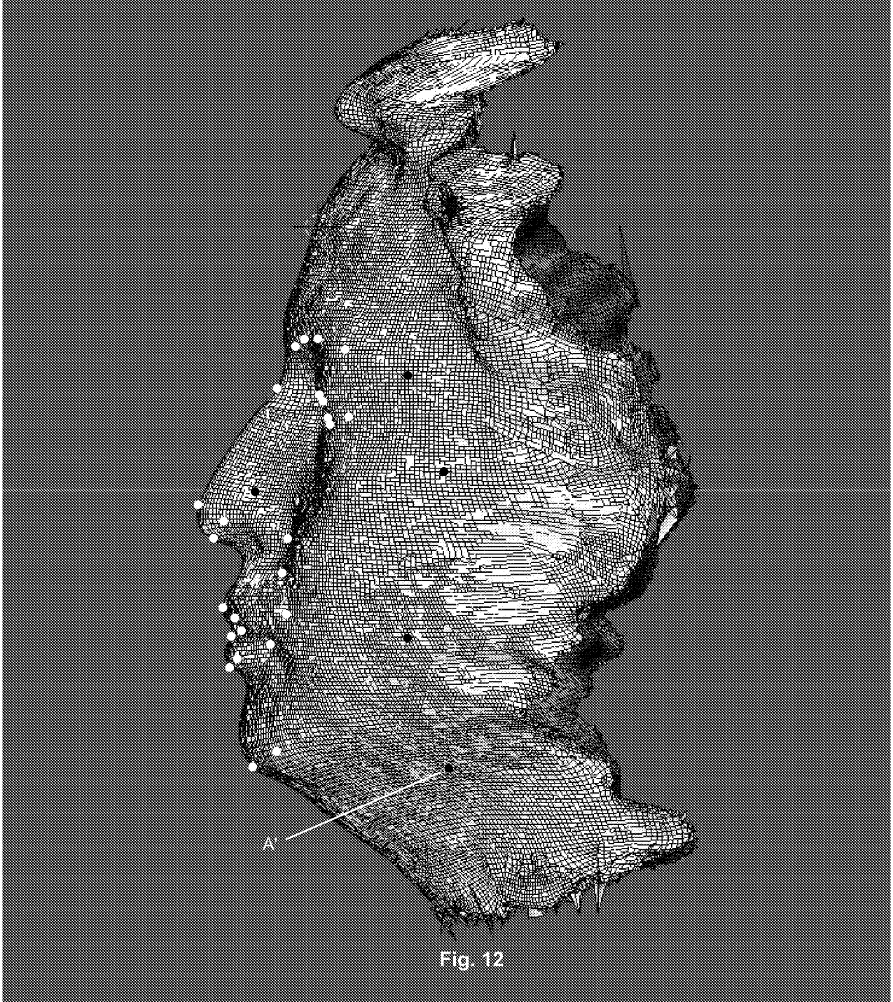

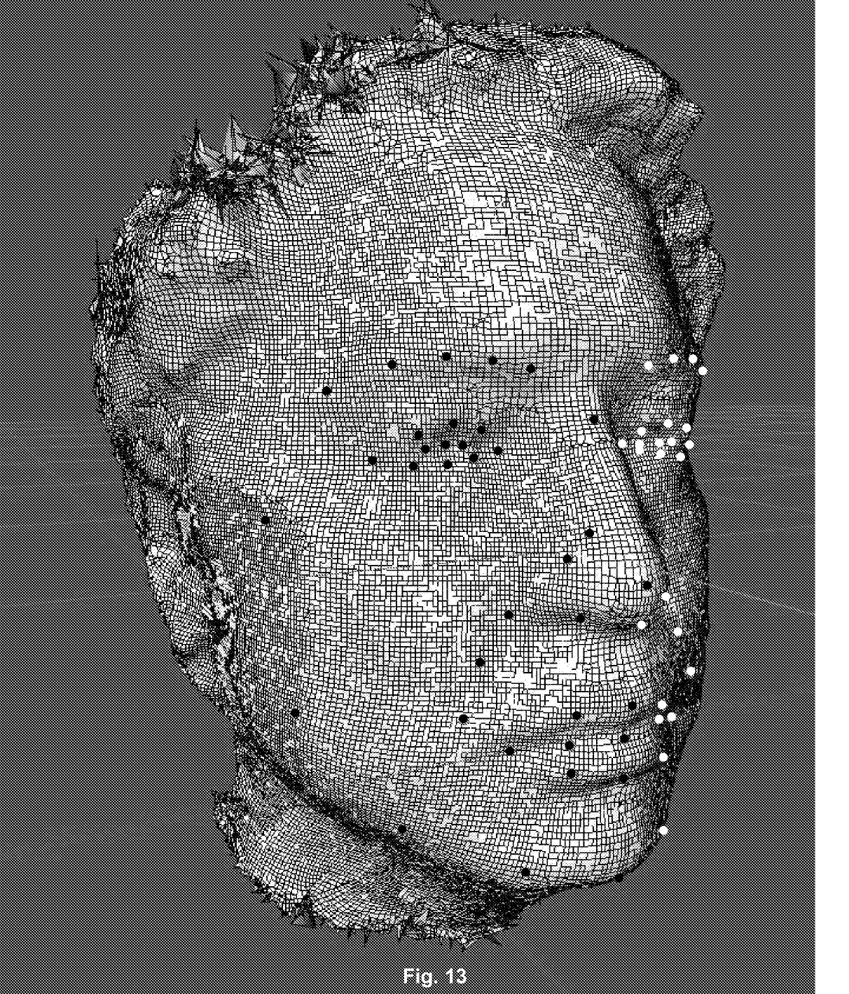

At 28 the identified frontal facial landmarks of the virtual 2-D image can be projected onto the feature points of the photogrammetric 3-D model, as shown in FIGS. 12-13. Thus, each facial landmark on the virtual 2-D image can have a corresponding feature point on the photogrammetric 3-D model. The 2-D frontal facial landmarks have been computed on an image that is preferably texture mapped to feature points on the photogrammetric 3-D model. There is generally a correspondence between a 2-D facial landmark coordinate and a feature point on the photogrammetric 3-D model. The photogrammetric 3-D model preferably includes a plurality of polygons. The polygons of the photogrammetric 3-D model, for example, can be triangles, quadrilaterals, or other multisided shapes. The step of projecting 2-D facial landmark coordinates onto the photogrammetric 3-D model may require identifying a polygon of the photogrammetric 3-D model that contains the texture coordinate corresponding to the 2-D facial landmark. In some embodiments, when the photogrammetric 3-D model may not be made of triangles, the photogrammetric 3-D model is preferably first triangulated before the step of projecting.

This projecting/mapping step can be done in a way that preserves the texture map of the original model. Given the (i,j) coordinates of a 2-D facial landmark, the (u,v) texture coordinates of this 2-D frontal facial landmark are:

u=i/w

v32 1−j/h,

where w and h are the width and height of the image, respectively.

In some embodiments where the polygons are preferably triangles, the texture mapping of the photogrammetric 3-D model defines the texture coordinates of each triangle's three vertices. Using the 3-D location of these vertices on the photogrammetric 3-D model and their assigned 2-D texture coordinate, a unique linear function can be defined:

f: R̂3→R̂2

This unique linear function can assign the 2-D texture coordinates to the triangle's vertices. An inverse of this function, f̂1(u,v), can be used to calculate the 3-D location of a vertex corresponding to a given texture coordinate. It is then determined whether the 3-D location is contained within the triangle. In some embodiments, inverse of the function can be defined to calculate the barycentric coordinates, (a,b), of the projected texture coordinate with respect to the triangle and thus determining if this point lies within the triangle by checking whether the condition is met: 0<=a & 0<=b & a+b<=1.

Accordingly, projecting the 2-D facial landmarks detected in the previous step may require iterating through at least some projected feature points and checking if the identified polygon on the photogrammetric 3-D model contains that projected feature point's texture coordinates. The photogrammetric 3-D model may contain tens of thousands of polygons. However, the number of feature points may be relatively small (on the order of 100 points). Therefore this process can take a short time to scale the feature points linearly with the size of the photogrammetric 3-D model. In some rare situations where a polygon cannot be identified to be projected to, the projection of that feature point can be marked as invalid and the method then proceeds with the next step. Doing this may not affect the whole process pipeline because the texture map may not need that feature point anyway.

Next, the normals of the polygons are computed for those polygons containing the projected feature points. Since the photogrammetric 3-D model provides more information than the 2-D image, some adjustments can be made by developing heuristics for moving features into certain positions based on the geometry of the photogrammetric 3-D model. For example, corrected position of the feature point is determined or estimated by incremental adjustments according to the additional information of the photogrammetric 3-D model. As shown in FIG. 12, for example, a projected feature point A′ on the photogrammetric 3-D model corresponding to the feature point A on the virtual 2-D image of FIG. 7 can be adjusted in this step. Once these adjustments are applied, the feature points can be re-projected down to the virtual 2-D image. This can be implemented by identifying a polygon containing the adjusted feature point (for example, the closest polygon to the adjusted feature point), then interpolating the texture coordinates of the vertices of the identified polygon and converting the texture coordinates back into the landmark coordinates on the virtual 2-D image.

At 30, a model of a generic 3-D mesh of a face or a head is provided with the pre-defined frontal feature points corresponding to those facial landmarks detected by the feature detection software. The generic 3-D mesh allows the photogrammetric 3-D model to be positioned in a known spatial position, orientation, and scale. Using the generic 3-D mesh along with the processing steps described herein can produce fixed projection matrices for viewing this mesh from the left and right profiles.

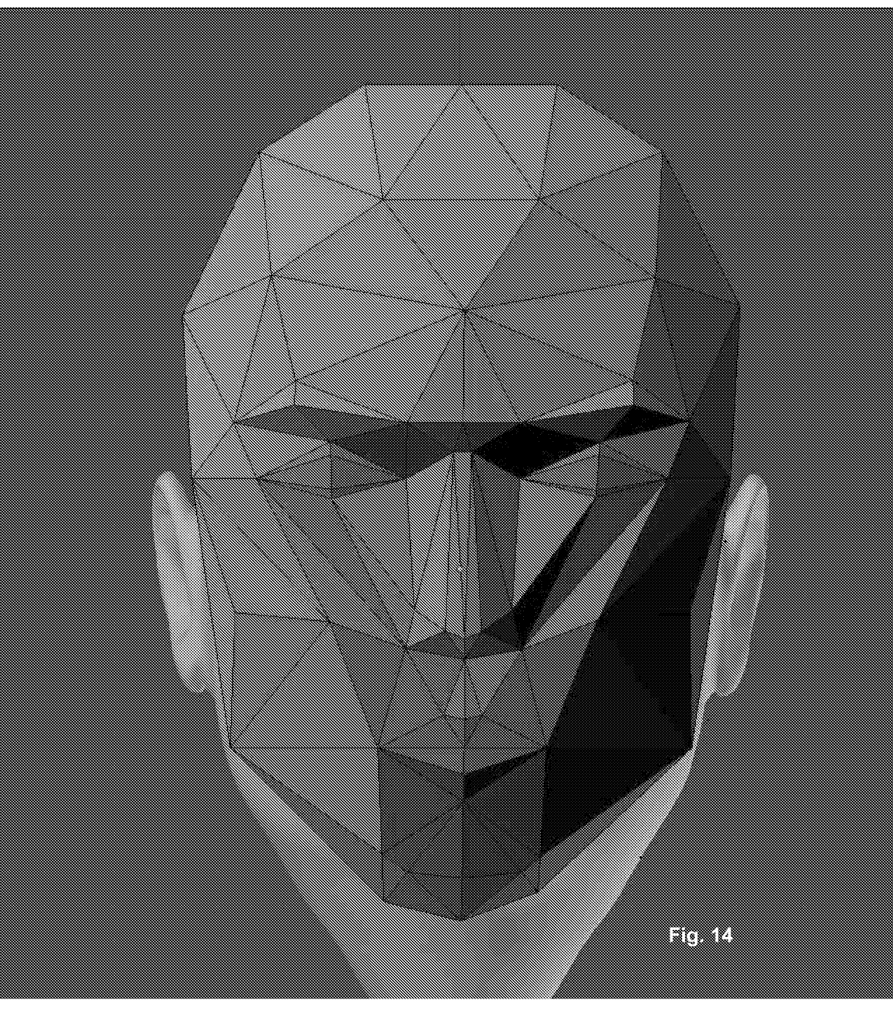

Step 30 includes fitting the generic 3-D mesh to the photogrammetric 3-D model. In some embodiments, the generic 3-D mesh is preferably a Candide mesh with pre-defined feature points placed. Candide mesh is a standardized simplified representation of a human face along with parameters controlling the overall shape of the face, as well as animation parameters. The Candide mesh can be positioned with pre-defined ideal feature points corresponding to the frontal facial landmarks that are automatically detected by the feature detection software. FIG. 14 illustrates an example of a Candide mesh with its polygons colored. The at least one pre-defined feature point location can be represented by a weighted sum of one or more vertices on the Candide mesh. For example, if a feature point lies in the middle along an edge connecting vertex v_i to vertex v_j, the position of that feature point can be represented as 0.5*v_i+0.5*v_j. Accordingly, the at least one pre-defined feature point can be moved with the vertices when the Candide mesh is being fit to the photogrammetric 3-D model.

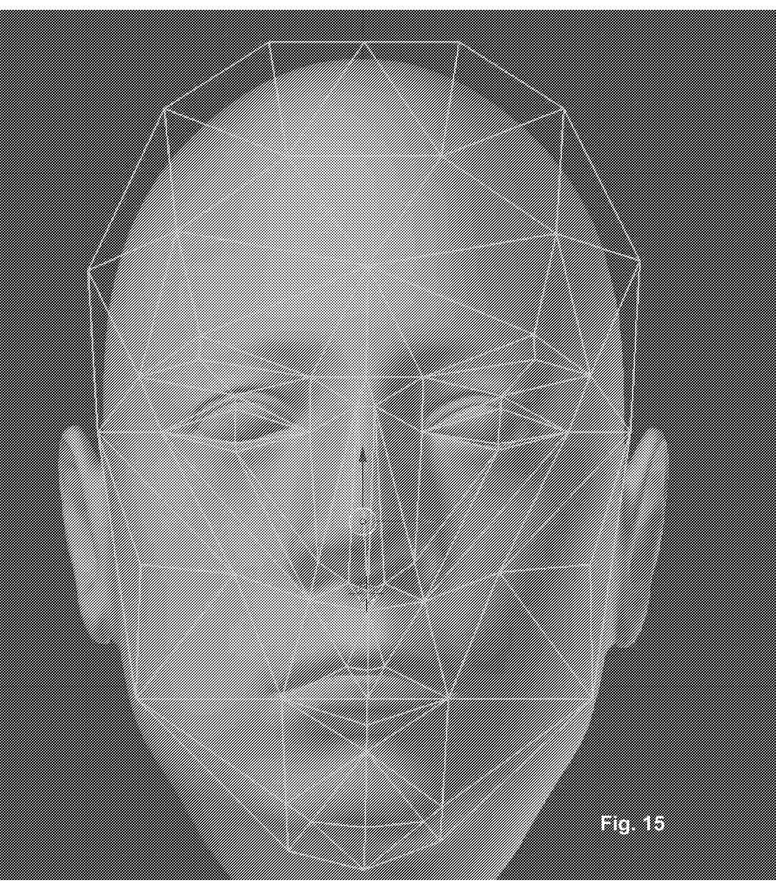

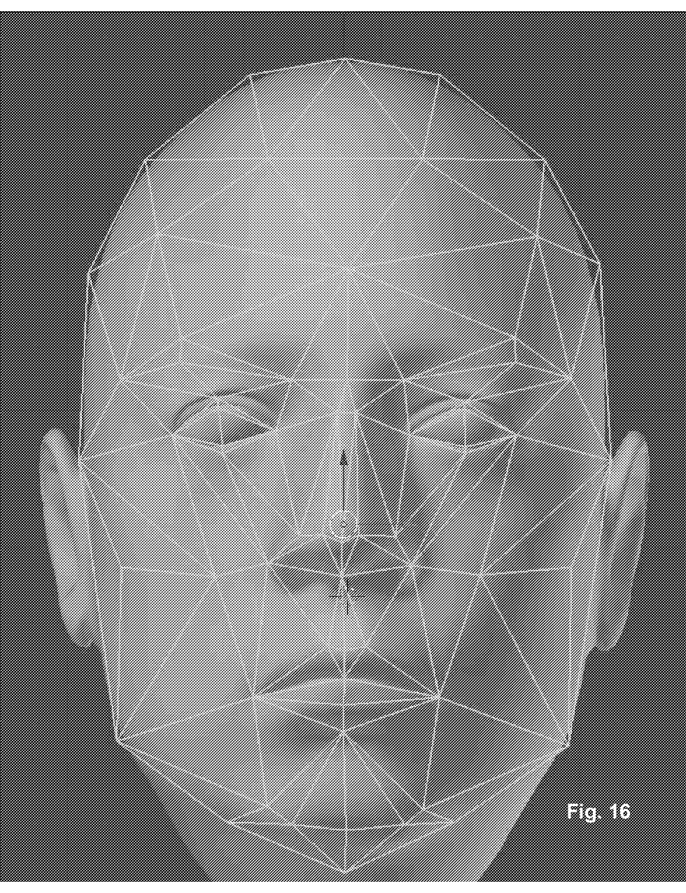

A goal of the fitting process is generally to minimize the distance between the corresponding pre-defined feature points on the Candide mesh and the feature points identified and projected on the photogrammetric 3-D model. The Candide mesh is designed for general use, which means it may not fit all particular faces. As shown in FIG. 15, an uncorrected Candide mesh is overlaid on a photogrammetric 3-D model of a head and distances exist between corresponding points between the Candide mesh and the photogrammetric 3-D model. For example, the outer line of the head, positions of eyes, nose and mouth, etc., do not match between the Candide mesh and the photogrammetric 3-D model. FIG. 16 shows the corrected Candide mesh overlaid on a photogrammetric 3-D model of the head and distances reduced between corresponding points between the Candide mesh and the photogrammetric 3-D model after the fitting process.

The fitting process generally includes two stages, global transformation and particular deformation. The global transformation can be implemented by performing at least one global correction parameter to at least some vertices of the polygons on the Candide mesh to match up with the photogrammetric 3-D model. The at least one global correction parameter can be calculated based on a relationship between the at least one projected feature point on the photogrammetric 3-D model and the at least one corresponding pre-defined feature point on the Candide mesh. The at least one global correction parameter preferably includes a scale, a rotation, and a translation to minimize an error function representative of the difference between corresponding points on the Candide mesh and the photogrammetric 3-D model.

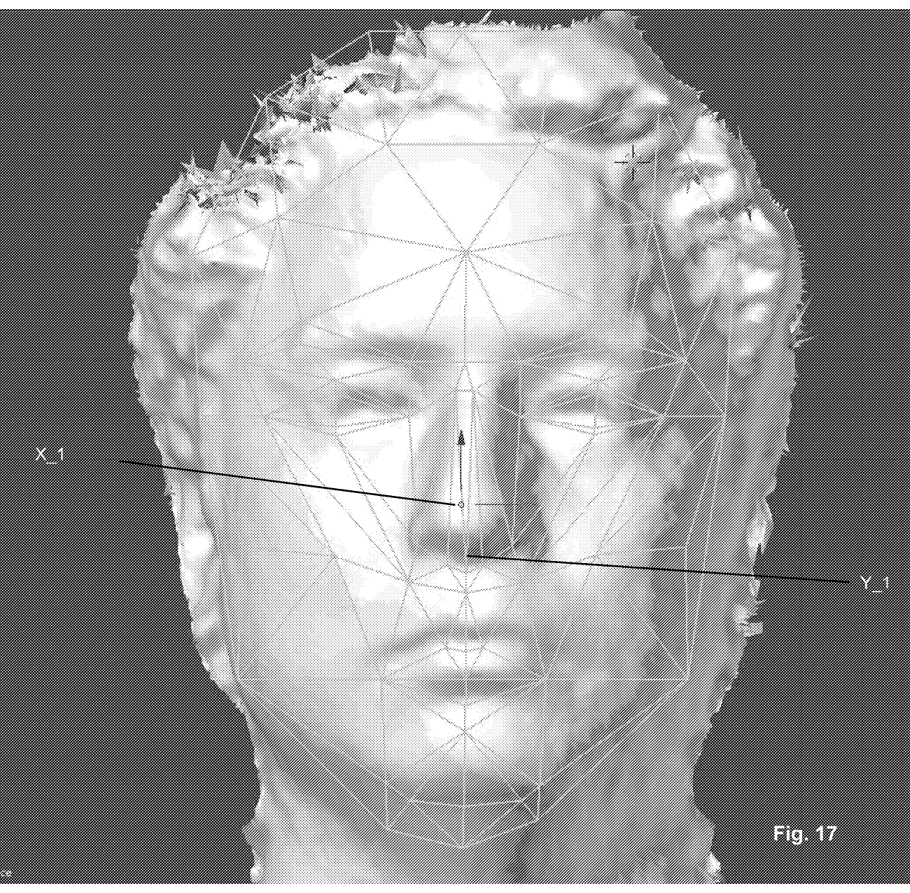

Pre-defined 3-D feature point locations, y_i, on the Candide mesh, and 3-D feature point locations, x_i, computed in the previous step on the photogrammetric 3-D model, generally correspond to the same feature. For example as shown in FIG. 17, a pre-defined 3-D feature point location y_1 and a feature point location x_1 both correspond to the tip of the nose on the Candide mesh and the photogrammetric 3-D model respectively. In a case when x_i was marked as invalid in a previous step, i.e., the step of projecting facial landmarks from the virtual 2-D image into the photogrammetric 3-D model, that x_i and the corresponding y_i may be excluded from the set of features in this step. In order to determine a scaling factor, s, a rotation matrix, Q, and a translation vector, t, such that s*Q*y_i+t can be as close as possible to x_i for each corresponding pair of feature points, the following mathematical formula can be used to minimize the error term:

Σ|s*Q*y_i+t−x_i|̂2

where the sum is taken over i,

One set of s, Q, and t is selected, preferably one that minimizes the above error term. Rotation is performed non-linearly. Such a non-linear optimization process can be implemented to solve the unknown parameters by using the Levenberg-Marquardt Algorithm from a third party solver, such as the open source Ceres solver. The process can be completed in less than a few seconds and can produce quite good results.

Additionally, the minimization results can be further improved by including the normal vectors at the feature points when calculating the rotation matrix Q. If the normal to the Candide mesh at y_i is m_i and the normal to the photogrammetry mesh at x_i is n_i, then the additional error terms can be added to the minimization operation:

Σ|Q*m_i−n_i|̂2

Automatically fitting a generic 3-D mesh to the known location of a photogrammetric 3-D model has many potential applications. The computed transformation can be applied to the generic 3-D mesh preferably before processing the profile feature point locations. Thus the orientation of the generic 3-D mesh can be used to define heuristics for computing additional profile features, and a fixed projection matrix can be used to transform the 3-D profile feature point locations back to a 2-D image plane. Accordingly having the generic 3-D mesh in a known position, orientation, and scale, is generally very useful for the remaining steps of the method.

The stage of a particular deformation generally includes solving at least one shape parameter. The at least one shape parameter can be used to indicate how much of a particular deformation is to be applied to at least one particular vertex of the generic 3-D mesh, for example a Candide mesh. The value of the at least one shape parameter can be, for example, a numeric value between 0 and 1, any other numeric value, or values in any other format. The at least one shape parameter can be applied to move the at least one particular vertex of the Candide mesh so that the transformed and deformed Candide mesh is personalized.

The global transformation and the particular deformation are preferably two independent process operations instead of a single combined process operation. Thus each process operation can be relatively simple and the fitting result can be more accurate.

As shown in FIG. 18, the corrected Candide mesh with corrected corresponding pre-defined feature point matches well with the photogrammetric 3-D mesh. For example, after transformed and deformed, the distance between the feature point y_i on the Candide mesh and the feature point x_i on the photogrammetric 3-D mesh is very small. And the point A″ which corresponds to the point A of FIG. 7 can be corrected to along the jaw line after the fitting process.

At 32, profile feature point locations are extrapolated on the transformed and deformed Candide mesh. Conventional 2-D facial landmark detection software packages can only detect features on 2-D frontal images of subjects' faces. Profile feature points from side images of subjects' faces are important and useful for defining the shape of the face, especially the nose and the chin, and therefore, automatically generating these profile feature points is generally important for making a personalized animatable mesh. Some of the relevant profile feature points may be included in the frontal feature points detected by the conventional facial landmark detection software, e.g., the tip of the nose, the chin, and the corner of the eye. These feature points are of interest and are preferably drawn from the feature points detected in the previous steps from a given profile (i.e., a left profile or a right profile).

There are additional profile feature points that are useful, but are not provided by the frontal detection algorithms. In some embodiments, these additional profile feature point locations can be extrapolated based on the known feature point locations on the Candide mesh. In some embodiments, this step can be implemented by computing a plane that contains all the known feature points along the outer edge of the profile, e.g. the bridge and tip of the nose, the top and bottom lips, and the chin. However, the eye corner may not be included in the plane because this eye corner generally does not lie in the same plane with the previous named known feature points.

Further, computing the plane may have a fitting problem due to inaccuracies in the feature detection from the previous steps. The projected detected feature points may not lie exactly on one plane. Thus in some embodiments, the plane is preferably determined by minimizing the sum of the squared distances of the feature points to the plane. The plane can be, for example, a vertical plane that bisects the face. A curve can be computed by the intersection of this plane with the photogrammetry mesh. At least one additional profile feature point can be assumed to be located along this curve. At least one new point can be inserted at a fixed distance, along the curve, between known feature points, e.g., the tip and bridge of the nose.

In some alternative embodiments, search criteria can be defined to identify at least one additional feature point based on the curvature of this curve. For example, a base of the nose can be found by walking along the curve from the tip of the nose toward the top lip. The slope of the tangent line may change while progressing along the curve. For example, some sections of the curve may be mostly horizontal, or closer to a horizontal direction than a vertical direction. Some sections of the curve may be mostly vertical, or closer to a vertical direction than a horizontal direction. A point on the curve where it changes from horizontal to vertical can be identified as a base of the nose.

Similar processes can be used to adjust feature points on the photogrammetric 3-D model that were computed in the 2-D picture as well. For example, such a process may be a necessary step to apply an adjustment to a chin point. In some embodiments, the heuristics for extrapolating and adjusting the frontal feature points on the photogrammetric 3-D model can be defined in a similar process. Different curves may be traced along the surface of the photogrammetric 3-D model to identify the additional feature point locations.

By using a Candide mesh, the feature points can be additionally or alternatively adjusted after fitting the photogrammetric 3-D model to a transformed and deformed Candide mesh. In particular, the fitting process can generally place feature points on the sides of the photogrammetric 3-D model of the face by the cheekbones, and along the jaw line (in line with the corners of the mouth). FaceSDK usually does not detect the cheekbone points, and sometimes does not place points along the jaw line in the correct position.

At 34 a personalized animatable mesh can be created by utilizing a FaceGen mesh with all the corrected 3-D feature point locations from the previous step and the virtual 2-D image.

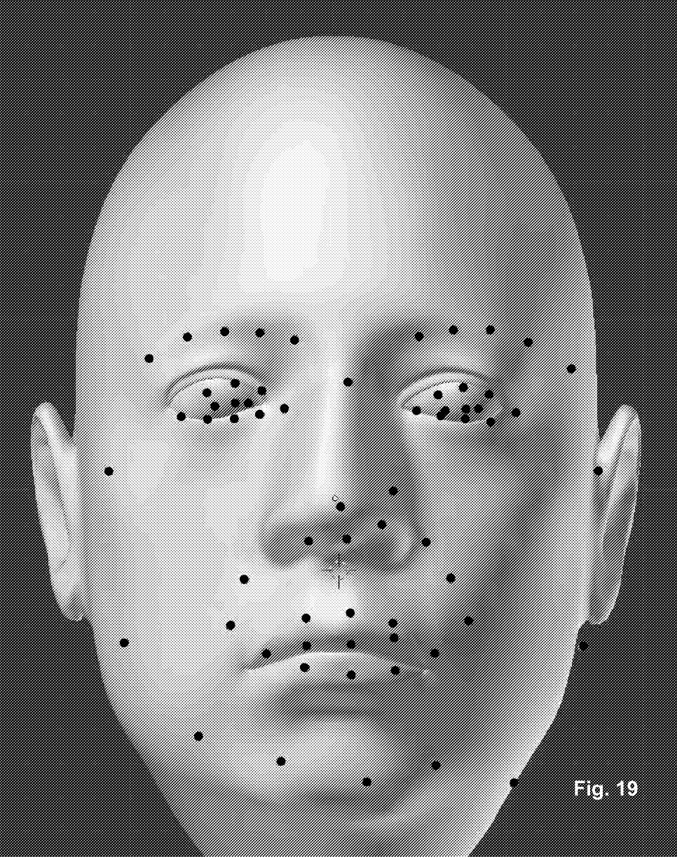

FaceGen is a 3-D face-generating 3-D modeling middleware produced by a third party. FaceGen generates conventional 3-D mesh data and uses a “parameterized” approach to define the properties that make up a face. FaceGen can generate 3-D models from front and side images of a face, or by analyzing a single photograph, and allow limited parametric control to randomize, modify the generated 3-D model. Generally, a FaceGen generated 3-D mesh includes fewer polygons than those of the photogrammetric 3-D model from the virtual 2-D image, and thus is easier to be controlled and operated for animation. For example, FIG. 19 depicts an exemplary FaceGen mesh with some feature points projected from a 2-D image. It can be seen that the projected feature point locations are not accurately positioned along the feature and shape of the FaceGen mesh. For example, a point at lower right corner is off the jaw line due to incorrect feature detection.

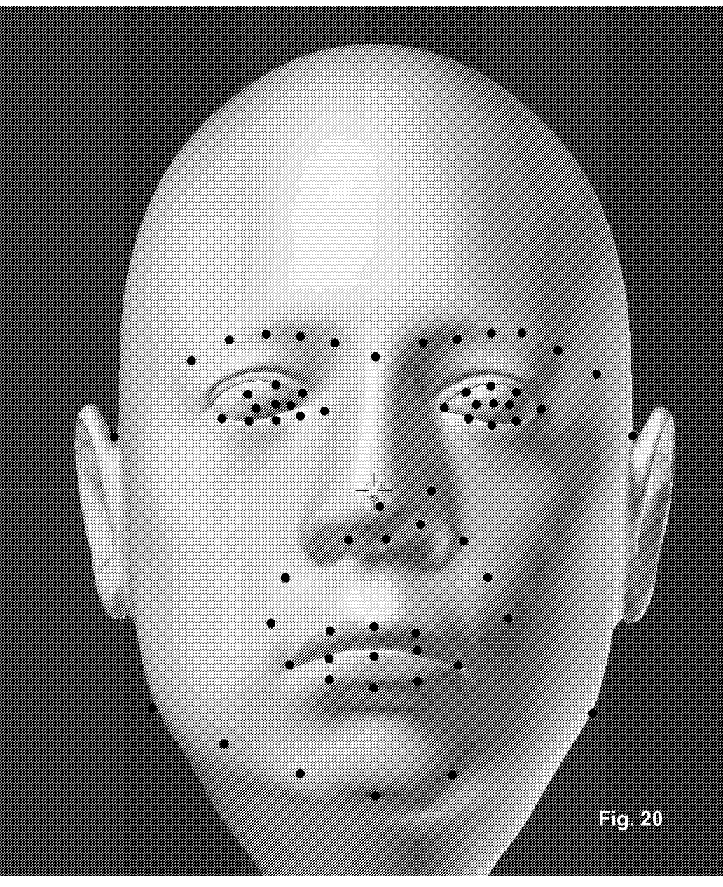

By fitting with the Candide mesh, the projected feature point locations can be corrected and the FaceGen mesh can be adjusted based on the corrected feature point locations. The animatable mesh is more personalized and has more realistic results, as shown in FIG. 20.

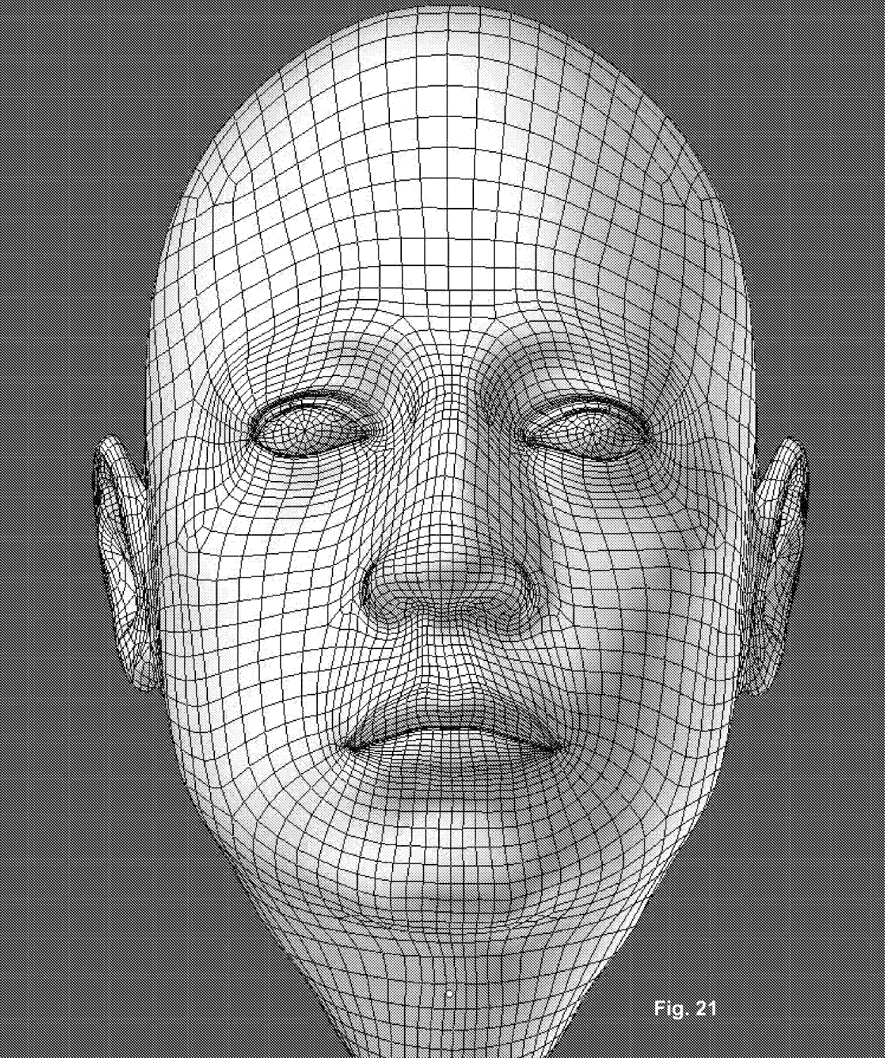

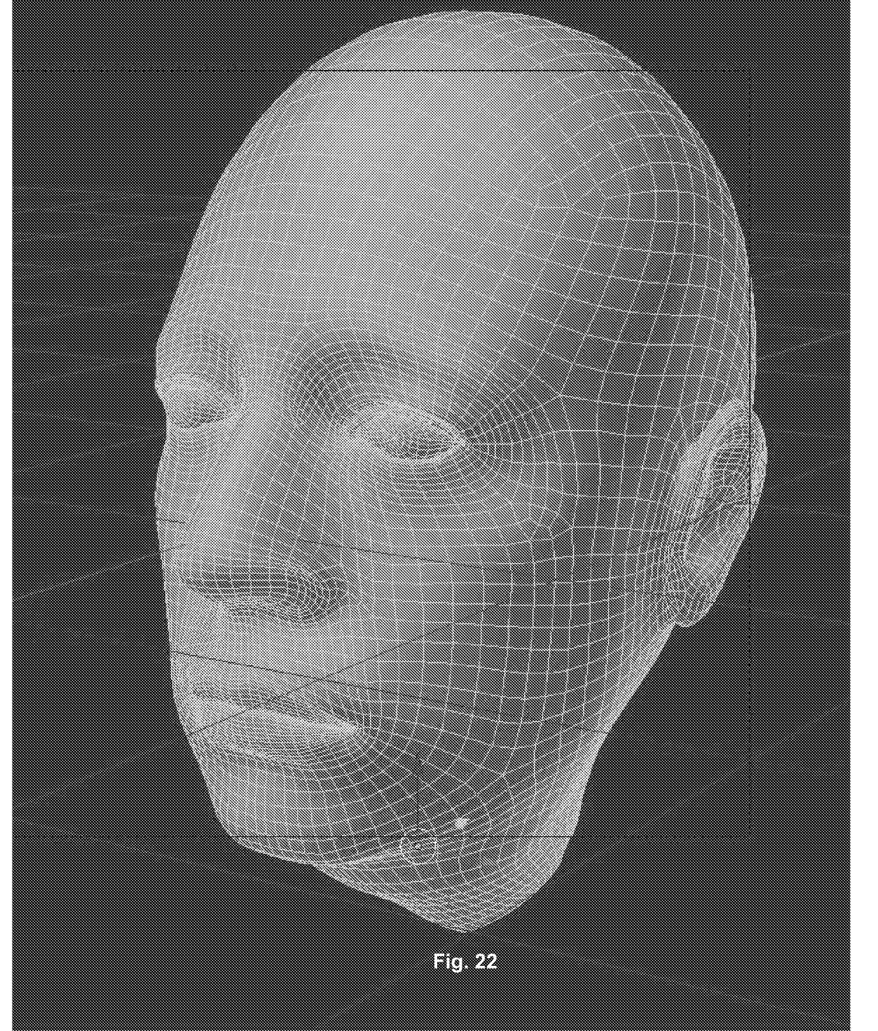

FIGS. 21 and 22 show frontal and perspective views of a FaceGen mesh generated based on the virtual 2-D image of FIG. 6.

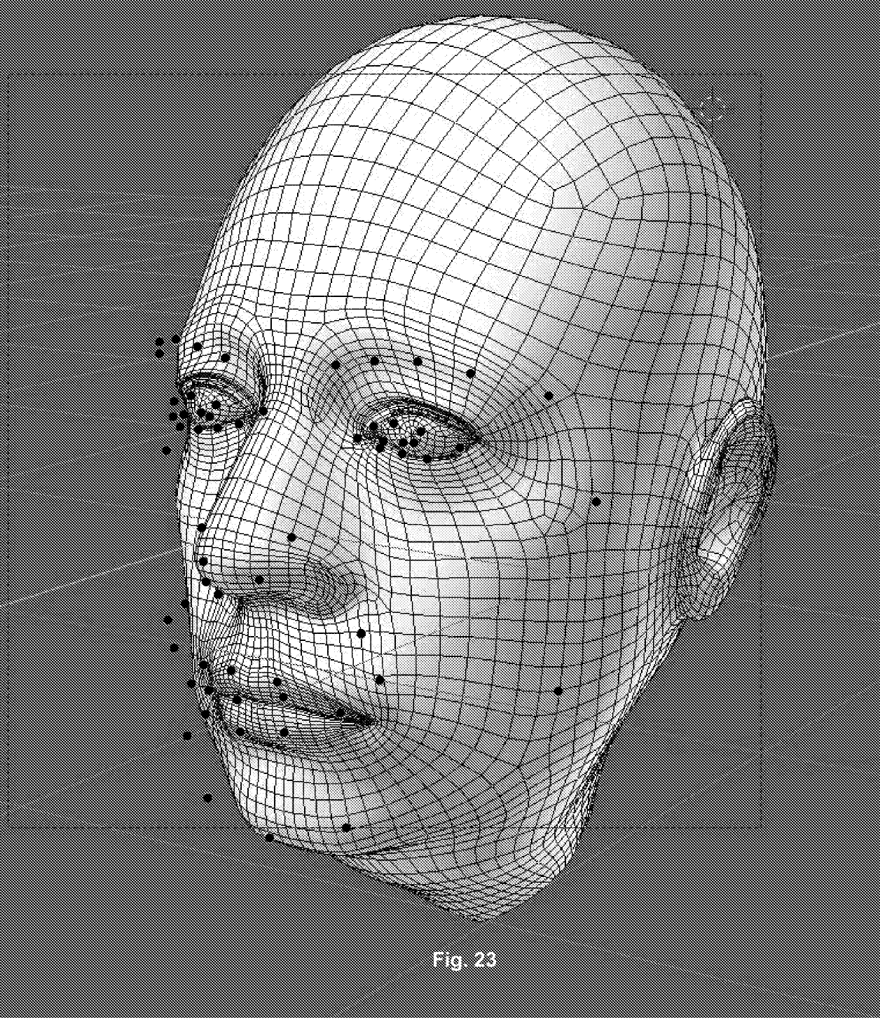

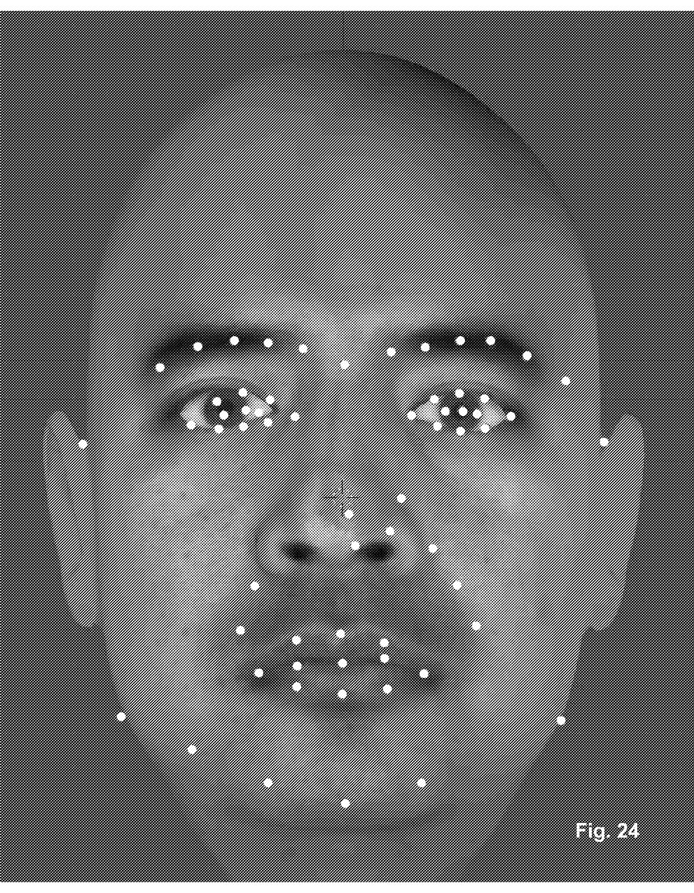

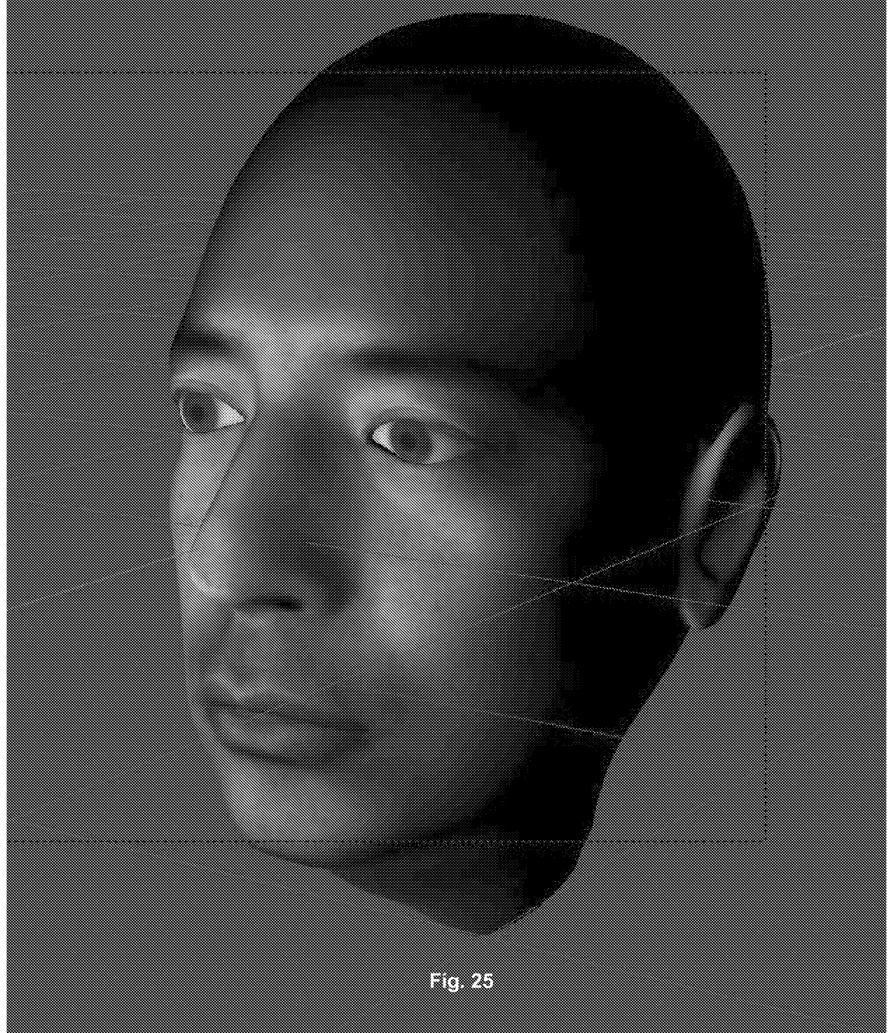

FIG. 23 depicts the generated FaceGen mesh having the identification of at least one feature point from the fitting operation. The at least one feature point is the at least one corrected pre-defined feature point from the Candide mesh of FIG. 18. The FaceGen mesh can be modified and textured based on the at least one corrected pre-defined feature point, as shown in FIG. 24. Finally a personalized animatable mesh can be generated as shown in FIG. 25.

Additionally, in some embodiments, profile views of the subject's face can be rendered with the 2-D profile feature point locations computed. A left and a right profile view can be generated by an interactive 3-D program, where a virtual camera can be moved around until a view of interest is obtained and a corresponding projection matrix can be written to a file. A custom OpenGL renderer can be used to load this projection matrix and a photogrammetry 3-D model can be rendered from the profile view. This can be done automatically by using feature point 3-D coordinates buffers for rendering and then storing the results in an image file, without having to open any interactive windows. The size of the resulting image can be chosen arbitrarily. Then the transformation from 3-D coordinates to 2-D feature point locations can be rendered. OpenGL can build this transformation from the various parameters provided, such as the projection matrix and the viewport size. By querying the full transformation matrix from the OpenGL engine the 3D profile feature points can be re-projected into the 2D image plane of the rendered profile image. Thus an automatic way of acquiring the 2-D profile facial feature point locations using only frontal facial feature detection software and a photogrammetric 3-D model of the subject's face can be provided.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of automatically identifying the required inputs for software for generating a personalized animatable mesh of a face, the method comprising:
computer processing a two-dimensional (2-D) image of the face to automatically identify at least one facial landmark on the 2-D image;
projecting the at least one identified facial landmark onto a photogrammetric three-dimensional (3-D) model of the face; and
computer processing the photogrammetric 3-D model of the face to automatically identify frontal and profile feature points on the photogrammetric 3-D model so that all of the required inputs are identified automatically without operator intervention.

2. The method according to claim 1, wherein the 2-D image is a virtual 2-D image comprising a plurality of frontal view features rendered from at least two 2-D images of the face.

3. The method according to claim 1, wherein the at least one facial landmark on the 2-D image is automatically identified by facial feature recognition software.

4. The method according to claim 1, wherein the photogrammetric 3-D model comprises a plurality of polygons with vertices.

5. The method according to claim 4, wherein the step of projecting the at least one identified facial landmark onto the photogrammetric 3-D model comprises texture mapping the at least one facial landmark onto at least one feature point on the photogrammetric 3-D model by identifying at least one polygon on the photogrammetric 3-D model, wherein the at least one identified polygon contains a texture coordinate corresponding to the at least one facial landmark.

6. The method according to claim 5, wherein the photogrammetric 3-D model is fit with a generic 3-D mesh by using the at least one identified feature point on the photogrammetric 3-D model.

7. The method according to claim 6, wherein the generic 3-D mesh is a Candide mesh.

8. The method according to claim 7, wherein the Candide mesh is globally transformed to reduce the distance between corresponding points between the Candide mesh and the photogrammetric 3-D model.

9. The method according to claim 8, wherein the transformed Candide mesh has at least one predefined feature point, and wherein the global transformation is implemented by calculating at least one global correction parameter based on a relationship between the at least one projected feature point on the photogrammetric 3-D model and the at least one corresponding pre-defined feature point on the Candide mesh.

10. The method according to claim 9, wherein the at least one global correction parameter comprises a scale, a rotation and a translation that minimize an error function representative of the distances between corresponding points on the Candide mesh and the photogrammetric 3-D model.

11. The method according to claim 9, wherein additional profile feature points are identified based on the corrected at least one corresponding pre-defined feature point of the transformed Candide mesh.

12. The method according to claim 9, wherein the at least one pre-defined feature point is represented by a weighted sum calculation.

13. The method according to claim 5, wherein the step of texture mapping the at least one facial landmark onto at least one identified feature point on the photogrammetric 3-D model comprises assigning one of the at least one identified feature point to a closest vertex on the photogrammetric 3-D model.

14. A method for automatically making a personalized animatable mesh of a face from at least two 2-D images of the face, the method comprising:
generating a virtual 2-D image from the at least two 2-D images;
identifying the location of at least one facial landmark on the virtual 2-D image;
mapping the at least one facial landmark identified on the virtual 2-D image to at least one frontal feature point on a photogrammetric 3-D model construed form the at least two 2-D images;
automatically calculating at least one global correction parameter based on a relationship between the mapped at least one frontal feature point on the photogrammetric 3-D model and at least one corresponding pre-defined feature point on a generic 3-D mesh;
applying the at least one global correction parameter to the generic 3-D mesh to match up with the photogrammetric 3-D model;
automatically extrapolating profile feature points on the corrected generic 3-D mesh based on the at least one corrected corresponding pre-defined feature point; and
creating the personalized animatable mesh of the face based on the at least one corrected corresponding pre-defined feature point and the virtual 2-D image.

15. The method according to claim 14, wherein the generic 3-D mesh is a Candide mesh having a plurality of polygons with vertices, wherein the step of applying the at least one global correction parameter to the generic 3-D mesh is moving at least some vertices of the Candide mesh based on the at least one global correction parameter.

16. The method according to claim 14, wherein the at least one global correction parameter comprises a scale, a rotation and a translation that minimizes an error function representative of the difference between corresponding points on the Candide mesh and the photogrammetric 3-D model.

17. The method according to claim 14, wherein the photogrammetric 3-D model comprises a plurality of polygons with vertices.

18. The method according to claim 17, wherein the step of mapping the at least one facial landmark of the virtual 2-D image to at least one frontal feature point on the photogrammetric 3-D model comprises assigning one of the at least one frontal feature point to a closest vertex of photogrammetric 3-D model.

19. The method according to claim 15 further comprising calculating at least one facial shape parameter for applying at least one particular deformation to at least one vertex on the Candide mesh so that the deformed Candide mesh is personalized, wherein the at least one vertex has been mapped to at least one frontal feature point of the photogrammetric 3-D model.

20. The method according to claim 14, wherein the step of automatically identifying the location of at least one facial landmark on the virtual 2-D image is based on at least one feature data in a statistical database.
